(19) United States
(12) Patent Application Publication
(10) Pub. No.: US 2018/0005327 A1
(43) Pub. Date: Jan. 4, 2018

(54) SYSTEM AND METHOD FOR FINDING LODGING FOR TOURING ARTISTS

(71) Applicant: TOURSLEEPER, LLC, North Attleborough, MA (US)

(72) Inventor: Daniel Bergeron, North Attleborough, MA (US)

(21) Appl. No.: 15/538,568

(22) PCT Filed: Mar. 16, 2016
(86) PCT No.: PCT/US16/22656

§ 371 Date: Jun. 21, 2017

Related U.S. Application Data
(60) Provisional application No. 62/135,283, filed on Mar. 19, 2015.

(51) Int. Cl. G06Q 50/12; G06Q 10/02; G06F 17/30; G06Q 30/02; G06Q 30/06

(52) U.S. Cl. CPC G06Q 50/12; G06Q 30/0282; G06Q 30/0611; G06F 17/3087; G06Q 10/025; G06Q 30/0641

(57) ABSTRACT

A lodging reservation system is configured to receive lodging requests and display the lodging requests through a user interface. The system receives lodging offers in response to the lodging requests, and transmits the lodging offers to the originator of the lodging request. The system further is configured to receive a selection of a lodging offer from the transmitted lodging offers.

### CROSS REFERENCE TO RELATED APPLICATION

This application claims priority to U.S. Provisional Application Ser. No. 62/135,283 entitled “SYSTEM AND METHOD FOR FINDING LODGING FOR TOURING ARTISTS,” filed on Mar. 19, 2015, which is incorporated herein by reference in its entirety.

### BACKGROUND OF THE DISCLOSURE

### 1. Field of the Disclosure

This disclosure relates to a lodging reservation system, and more particularly to a lodging reservation system that is tailored to touring artists.

### 2. Discussion of Related Art

In order to obtain and expand a fan base, artists can advertise their work to potential fans. One method of accomplishing this goal is for an artist to go on tour. However, touring has disadvantages; for example, artists on tour need to locate and reserve lodging between performances. Booking lodging for each day of a tour is both expensive and time-consuming, as artists often must reserve lodging in advance for each tour destination.

### SUMMARY OF THE DISCLOSURE

A solution to the above problems is for a touring artist to stay with fans along a tour route. In exchange, the touring artist can offer exclusive deals on artist merchandise or tickets to artist performances, eliminating or ameliorating lodging costs. Additionally, the touring artist, can post a tour schedule for review by potential hosts and can receive lodging offers from fans, significantly reducing the time investment necessary for an artist to schedule lodging accommodations. Furthermore, by publicly posting the tour schedule for viewing by potential fans, the artist also indirectly receives publicity while searching for lodging accommodations.

According to one example, a lodging reservation system for touring artists comprises a user interface, a memory, and a controller coupled to the memory. The controller is configured to receive at, least one date and at least one associated location from a touring artist, display the at least one date and the at least one associated location via the user interface, receive at least one lodging offer from a host, transmit the at least one lodging offer to the touring artist, and receive at least one lodging selection from the touring artist.

In one example, the controller further is configured to transmit a list of one or more artist packages to the host, and receive a selection of an artist package from the list of one or more artist packages from the host. In another example, the artist package includes at least one of CDs, posters, show tickets, and apparel. In another example, the controller further is configured to receive a review of the touring artist from the host. In yet another example, the controller further is configured to prioritize displaying date and location information for the touring artist responsive to the touring artist meeting a first criterion.

In one example, the first criterion is one or more of a high popularity rating of the touring artist, a fee being paid by the touring artist, and a system membership account being held by the touring artist. In another example, the controller further is configured to receive a search request including a location. In another example, the user interface is configured to display one or more lodging requests near the location. In another example, the at least one lodging offer includes an aggregate rating and one or more reviews. In yet another example, the at least one lodging offer includes a description and images of the offered lodging.

According to one example, a method of finding lodging for touring artists comprises receiving at least one date and at least one associated location from a touring artist, displaying the at least one date and the at least one associated location via a user interface, receiving at least one lodging offer from a host, transmitting the at least one lodging offer to the touring artist, and receiving at least one lodging selection from the touring artist.

In one example, the method further comprises transmitting a list of one or more artist packages to the host, and receiving a selection of an artist package from the list of one or more artist packages from the host. In another example, the artist package includes at least one of one or more CDs, posters, show tickets, and apparel. In another example, the method further comprises receiving a review of the touring artist from the host. In another example, the method further comprises prioritizing displaying date and location information for the touring artist responsive to the touring artist meeting a first criterion.

In one example, the first criterion includes at least one of a high popularity rating of the touring artist, a fee being paid by the touring artist, and a system membership account being held by the touring artist. In another example, the method further comprises receiving a search request including a location. In another example, the method further comprises displaying one or more lodging requests near the location by the user interface. In another example, the at least one lodging offer includes an aggregate rating and one or more reviews. In another example, the at least one lodging offer includes a description and images of the offered lodging.

### DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1 is a process flow chart used to determine steps taken by a touring artist to find lodging;

FIG. 2 is an exemplary user interface view of a lodging offer;

FIG. 3 is a process flow chart used to determine steps taken by a potential host to provide lodging to a touring artist;

FIG. 4 is an exemplary user interface view of a lodging request; and

FIG. 5 is a block diagram of one example of a computer system that may be used to perform processes and functions disclosed herein.

### DETAILED DESCRIPTION OF THE DISCLOSURE

This disclosure is not limited in its application to the details of construction and the arrangements of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present disclosure is directed to a lodging reservation system for connecting touring artists (e.g., musicians, sculptors, authors, comedians, etc.) with hosts offering lodging to the artist(s). It is to be understood, however, that the lodging reservation system can be used for connecting any person or people (e.g., professional athletes, amateur athletes, etc.) in need of lodging with hosts offering lodging. The system includes a controller configured to receive, from an artist, tour information including a list of tour dates and locations. The controller further is configured to extract dates and locations for which lodging is required from the tour information, and display the lodging requirements via a user interface. The controller receives one or more lodging offers from one or more potential hosts, sends the lodging offer(s) to the artist, and receives a selection of a lodging offer from the artist. In exchange, the artist can offer the host a special package (e.g., CDs, tickets to the artist's show, merchandise, etc.) at reduced or no cost as payment. The controller further is configured to receive reviews from the host and the artist containing an evaluation of the opposite party, and display the content of the reviews for other users' (e.g., potential hosts or artists) consideration.

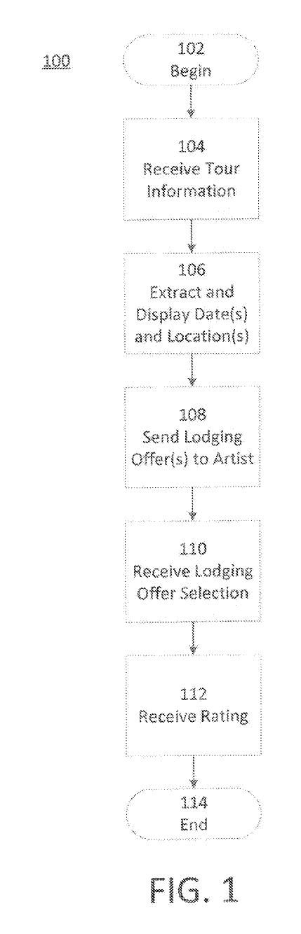

FIG. 1 illustrates a process 100 executed by a controller for sending and receiving information from a touring artist. Generally speaking, the process 100 involves the controller receiving tour information from an artist, supplying lodging offers to the artist, and collecting feedback from the artist after the artist has taken advantage of a lodging offer.

At step 102, the process 100 begins. At step 104, the controller receives tour information from an artist. For example, the tour information can include one or more locations (e.g., cities or venues) and one or more dates on which the artist will be at an associated location. At step 106, the date(s) and location(s) are extracted from the tour information and are stored in a memory by the controller, and each date-location pair is used by the controller to generate one or more lodging requests to display to potential hosts via a user interface.

In some embodiments, the controller may need to extrapolate some or all of the details of the lodging request. For example, the tour information may include a range of dates (e.g., February 15^{th} through February 18^{th}) for an associated venue (e.g., “Madison Square Garden”) at which the artist is performing. In the foregoing example, the controller may extrapolate that the artist will need lodging from the evening of February 15^{th} through the morning of February 19^{th}, and may further extrapolate that the artist needs lodging in or around Manhattan, N.Y.

Furthermore, the tour information received by the controller may include special instructions or other additional information that cannot be extracted from the date and location information alone. For example, the tour information may include a requirement that lodging offers be located within a certain radius of a venue, or be in the same town, city, etc. as the venue. The tour information further may include a requirement that additional dates beyond the touring dates be available for lodging or, for events spanning multiple days, that any lodging offers be valid for each of the multiple days.

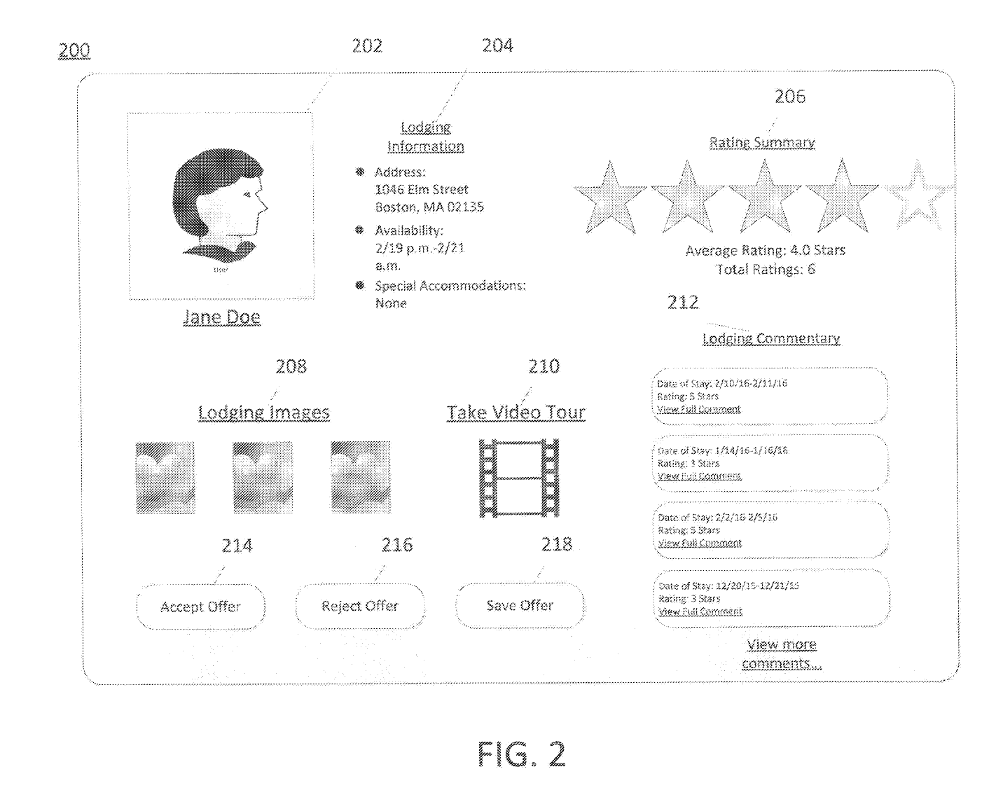

As explained in more detail below with respect to FIG. 2, potential hosts can submit lodging offers to artists by submitting a response to lodging requests displayed via the user interface. At step 108, lodging offers are sent to an artist that created a lodging request. Lodging offers may be sent to the artist as soon as the offers are received by the controller, or the offers may be stored by the controller in the memory and sent to the artist according to fixed or non-fixed intervals.

FIG. 2 shows an example of a lodging offer 200 displayed by the user interface as it appears to a touring artist that receives the lodging offer 200. The lodging offer 200 includes user information 202, lodging information 204, a rating summary information section 206, lodging images 208, a lodging video tour 210, a lodging commentary section 212, an accept offer button 214, a reject offer button 216, and a save offer button 218.

The user information 202 includes basic information about the user offering to host the touring artist. For example, the user information 202 section can include a picture of the user, the user's name, and so forth. The lodging information 204 includes key information about the lodging being offered by the user. For example, the lodging information 204 can include an address of the lodging being offered, a description of a residence type (e.g., townhouse, apartment, etc.), a residence availability, a list of special accommodations (e.g., a free meal being included with the lodging), a description of the lodging and any included amenities, and so forth.

The rating summary information section 206 includes a numerical rating (e.g., based on a 5-point scale, a 10-point scale, a 100-point scale, etc.) of the user. For example, the rating summary information 206 may include a cumulative rating on a 5-star rating scale and further may include the number of ratings used to calculate the cumulative rating. In other examples, the numerical rating may be restricted, exclusively to recent ratings (e.g., the most recent 5 ratings, all ratings within the last three months, etc.) and may not specify the total number of ratings for the user. Furthermore, a minimum number of ratings may be necessary for a cumulative numerical rating to be displayed.

The lodging images 208 include images of the lodging being offered by the user. Examples of images may include images of a room being offered, images of a bathroom offered with the room, images of any special accommodations or amenities being provided, and so forth. The lodging video tour section 210 can include an embedded video or a link to an externally-hosted video, taken by the user, providing a virtual tour of the lodging being offered to potential guests.

In some examples, the user may choose not to post one or both of the video tour or the lodging images. However, touring artists may specify, when posting lodging requests, that lodging offers must include images and/or video tours for a lodging offer to be submitted for consideration.

The lodging commentary section 212 includes comments and reviews from previous guests of the user that submitted the lodging offer 200. For example, the lodging commentary section 212 can provide a brief overview of the previous guests' experiences, including, for example, a range of dates over which a particular guest stayed with the user, a rating given by the guest to the user, and a brief snapshot of the guest's commentary with a button to fully expand the content of the comment. The lodging commentary section 212 further can include a button to display more or all of the comments, if more commentary exists for the user. In some examples, the lodging commentary section 212 can be sorted by comment date, comment rating, and so forth.

If a touring artist decides to accept the lodging offer 200, the touring artist can select the accept offer button 214. Otherwise, if the touring artist decides to reject the lodging offer 200, the touring artist can select the reject offer button 216. In some embodiments, responsive to receiving selection of the accept offer button 214 or the reject offer button 216, the controller sends a notification to the user that sent the lodging offer 200 indicating that the offer has been accepted or rejected. In other embodiments, no notification is sent if the artist rejects the offer. The touring artist may otherwise select the save offer button 218 if the touring artist is unsure as to whether to accept or reject the offer and wants to save the offer for a later time.

Returning to FIG. 1, at step 110, the controller receives a selection of a lodging offer (e.g., lodging offer 200) from a touring artist. As mentioned above, a notification is sent to the user that submitted the lodging offer, alerting the user to the touring artist's decision. In some embodiments, the controller may facilitate the exchange of personal contact information (e.g., e-mail addresses, phone numbers, etc.) between the touring artist and the host when a lodging offer is accepted, while in other embodiments, no personal information is exchanged and all communication is required to take place through the system. For example, the system can include a messaging feature through which the artist and the host can communicate to ensure both parties' privacy.

At step 112, after the touring artist has utilized the lodging, the controller may receive a review from the touring artist. For example, the review can include a rating of the lodging experience, comments about the lodging experience, a range of dates over which the lodging was utilized, and so forth. The controller can store the review received at step 112 in the memory, and include the information from the review in a summary of the host to display in the future. At step 114, the process 100 ends.

In some examples, a host that receives a certain number of favorable reviews can be highlighted by the system and receive preferential representation. For example, when submitting lodging offers to touring artists, the system may include a special indication on lodging offers submitted by the host identifying him or her as a favored host.

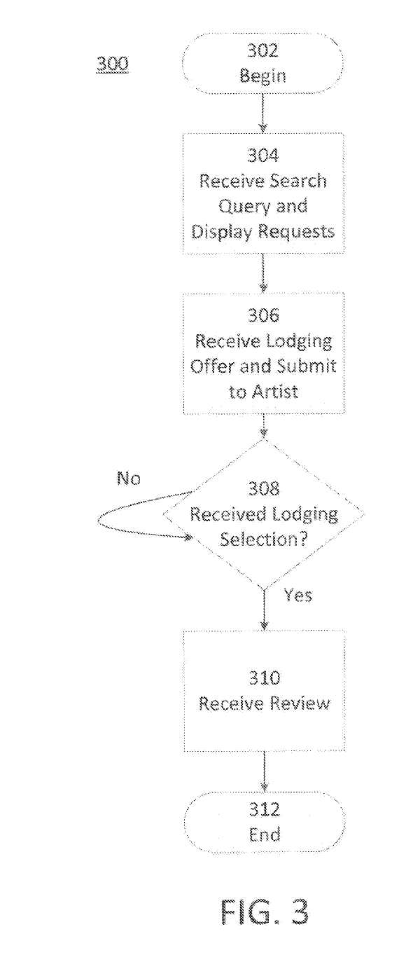

FIG. 3 illustrates a process 300 executed by a controller for sending and receiving information from a user offering lodging to touring artists. Generally speaking, the process 300 involves a controller receiving a search query from a user, displaying results of the search query, receiving submission of a lodging offer from the user, submitting the lodging offer to a touring artist, receiving acceptance of the lodging offer from the touring artist, and receiving a subsequent review of the lodging experience from the user.

At step 302, the process begins. At step 304, the controller receives a search query for artist lodging requests from the user. For example, the query may include a genre of music, a specific artist's name, or a location (e.g., a city, a town, a ZIP code, a venue, etc.) around which to search for artists. In some examples, the controller can accept parameters restricting the search results to a specific radius around the entered location, or may accept parameters specifying a range of dates over which to search for touring artists within a specified region. The controller searches for any lodging requests that substantially meet the specifications of the query, and displays any matching lodging requests via the user interface.

In other embodiments, the controller may automatically submit notifications to users if touring artists post lodging requests proximate to a user's location (e.g., within the same ZIP code). In one example, the controller can prompt the user to create a profile that includes the user's location and, in some examples, an e-mail address. As touring artists post lodging requests proximate to the user's location, the controller can automatically submit a notification to the user's e-mail address to notify the user of the potential to host the touring artist. Notifications can be sent to the user as soon as touring artists post nearby lodging requests in some examples, while in others, the controller can send notifications to the user at fixed or non-fixed intervals.

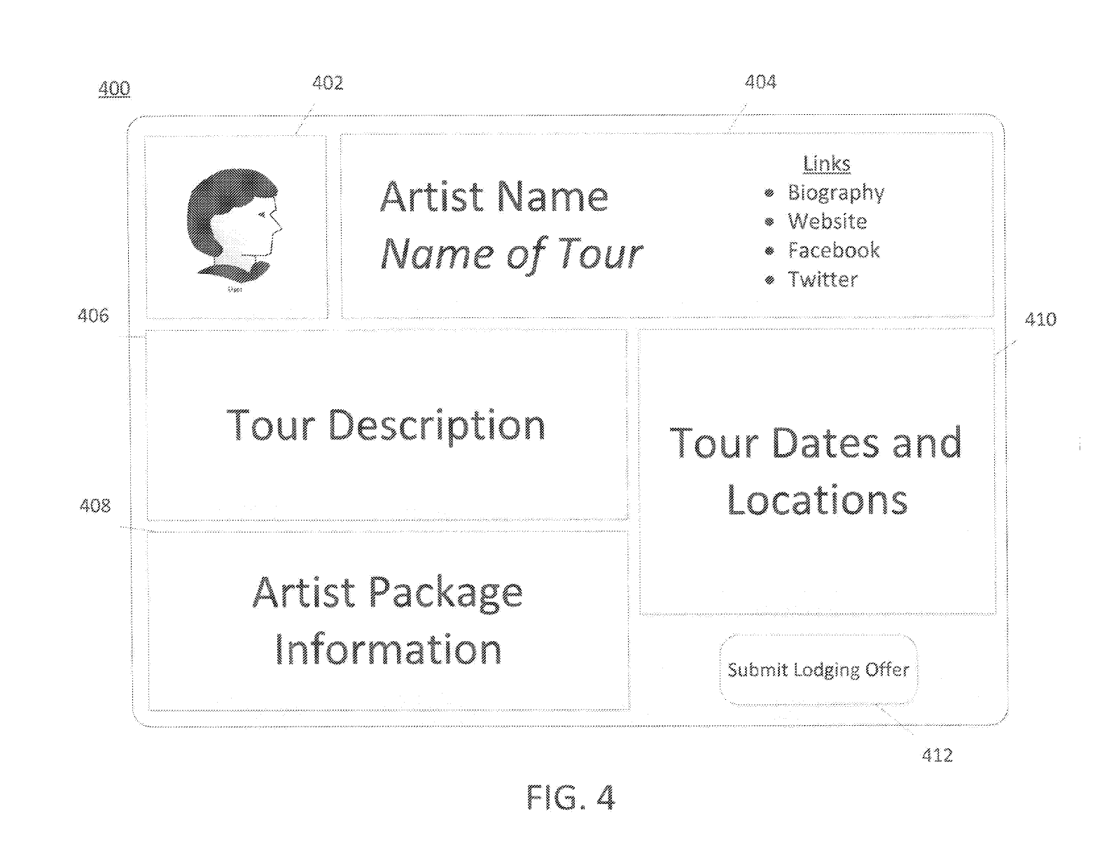

FIG. 4 shows one example of a lodging request 400 displayed by the user interface once the request has been submitted by a touring artist. The lodging request 400 includes an artist picture 402, an artist information section 404, a tour description section 406, an artist package section 408, a tour dates and location section 410 and a submit lodging offer button 412.

The artist picture 402 is a picture of the touring artist or group of artists (e.g., a band of musicians). The artist information section 404 includes a name of the artist, a name of the artist's tour, and a list of links that lead to additional information pertaining to the artist. The tour description section 406 includes a description of the tour and may include a note from the artist explaining a need for support from fans (e.g., support in the form of providing lodging).

The artist package section 408 includes a list (e.g., a textual list, a visual mosaic of descriptive tiles, etc.) of packages offered by the artist to hosts. For example, the packages can include free or reduced cost merchandise (e.g., CDs, music download codes, clothing, posters, etc.), free or reduced cost tickets to shows, and so forth. In some examples, the artist package section 408 may not include any package information (i.e., no packages are offered).

Packages including reduced cost merchandise and reduced cost tickets can be offered exclusively to the host of the touring artist. The controller collects payment for the selected package from the host and automatically transfers the payment to the touring artist. In some embodiments, the system collects a portion of the payment as a processing fee. The touring artist delivers the package to the host upon arrival at the lodging.

The tour dates and location section 410 includes a list of locations (e.g., venues, towns, cities, etc.) at which the artist is performing and the dates on which the artist is performing at the associated location. Responsive to selection of the submit lodging offer button 412, the controller sends a lodging offer, such as lodging offer 200, to the touring artist that posted the lodging request 400.

Returning to FIG. 3, at step 306, the controller receives a lodging offer from a user responsive to user selection of the submit lodging offer button 412. The controller sends the lodging offer to the artist, as explained above at step 108 of process 100. At step 308, the controller evaluates whether the controller has received a response from the artist indicating that the artist has accepted the lodging offer. If the controller receives the notification (308 YES), then the process continues to step 310. Otherwise (308 NO), the process 300 returns to step 308.

At step 310, the controller receives a review of the lodging experience from the user. For example, the review can include a rating of the artist as a guest, comments about the artist, and so forth. At step 312, the process 300 ends.

In the foregoing discussion, the user interface has been described primarily as a medium through which to display lodging offers and lodging requests. However, the controller may also prompt users (e.g., hosts, artists, etc.) via the user interface to create user profiles associated with the system. Host profiles can be displayed and promoted via the user interface on the home page of the system to other users if the host has met certain criteria, such as attaining a certain threshold of favorable reviews.

Artist profiles can be displayed on certain users' home pages under certain conditions such as, for example, a user being proximate to an upcoming tour location, the system receiving a fee from a touring artist, a high rating being held by the touring artist, and so forth. Alternatively, artist thumbnails containing basic artist information such as an artist's name, picture tour name and tour date range may be displayed by the controller in lieu of full artist profiles.

Responsive to receiving selection of an artist thumbnail, the controller is operable to display artist profile information including, for example, links to an artist's website and social media accounts, a calendar of nights for which lodging is needed by the artist, a list of artist packages, and so forth. The calendar can display nights that the artist has already acquired housing for in addition to nights for which the artist is still accepting lodging offers.

A user can access one's own profile to view, for example, a calendar (e.g., including days that a user is hosting an artist), reviews of and reviews by the user, payments made or received, alerts, messages in an inbox, upcoming reservations, and so forth. In some examples, a user may provide private feedback to another user which may be accessible for viewing only through accessing one's own profile.

Furthermore, the system can display an instructional system overview video on the home page. The system overview video can include information geared towards hosts, artists and fans in general. The system overview video can provide tutorial information to acclimate a user to the system, and encourage the user to create a profile to maximize the benefits of using the system.

Some examples discussed herein have been directed to situations wherein a lodging location at which a touring artist will stay is separate from a venue at which an artist is performing. For example, an artist may perform at a concert hall but stay at a host's home, which is distinct from the concert hall. However, in some examples, a host's home can also be a location at which a concert is performed.

For example, a touring artist can, rather than entering one or more tour dates and associated locations, post a request for users in a general geographic area to host a house concert within a specified range of dates. The artist can specify guidelines for the house concert, including minimum fees, whether merchandise sales support from the host will be necessary, whether the host should organize dinner, and so forth.

Moreover, the foregoing discussion has been directed largely to touring artists visiting multiple locations on multiple dates. However, it is to be understood that a person or group of people in need of lodging may only need lodging in a single location, for one or multiple days. For example, an event (e.g., a competition, a convention, etc.) may be located in a city remote from an attendee or group of attendees that wish to find lodging using the lodging reservation system for one or multiple days. The lodging reservation system is operable to receive the date and location information as described above with reference to the receipt of multiple dates and locations.

Various aspects and functions described herein may be included as specialized hardware or software components executing in one or more computer systems. One or more acts of the method described above may be performed with a computer, where at least one act is performed in a software program housed in a computer. Non-limiting examples of computer systems include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

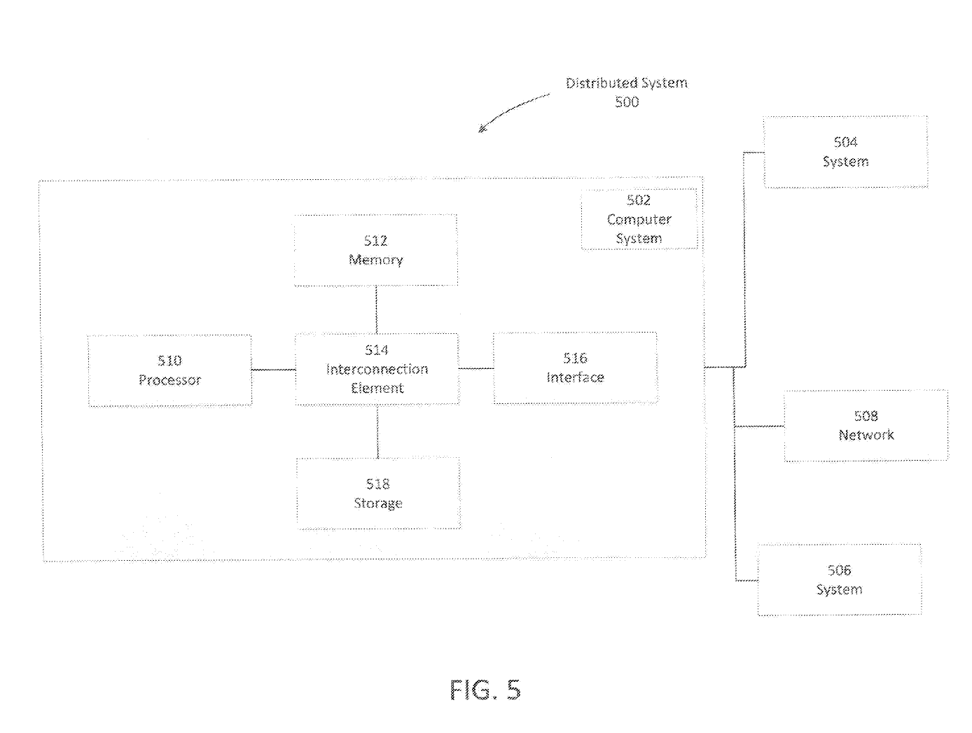

Referring to FIG. 5, there is illustrated a block diagram of a distributed computer system 500, in which various aspects and functions are practiced. As shown, the distributed computer system 500 includes one or more computer systems that exchange information. More specifically, the distributed computer system 500 includes computer systems/devices 502, 504 and 506. As shown, the computer systems/devices 502, 504 and 506 are interconnected by, and may exchange data through, a communication network 508. The network 508 may include any communication network through which computer systems may exchange data. To exchange data using the network 508, the computer systems/devices 502, 504 and 506 and the network 508 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 502, 504 and 506 may transmit data via the network 508 using a variety of security measures including, for example, TLS, SSL or VPN. While the distributed computer system 500 illustrates three networked computer systems, the distributed computer system 500 is not so limited and may include any number of computer systems and computing devices, networked using any medium and communication protocol.

As illustrated in FIG. 5, the computer system 502 includes a processor 510, a memory 512, an interconnection element 514, an interface 516 and data storage element 518. To implement at least some of the aspects, functions and processes disclosed herein, the processor 510 performs a series of instructions that result in manipulated data. The processor 510 may be any type of processor, multiprocessor or controller. Some example processors include commercially available processors such as an Intel Atom, Itanium, Core, Celeron, or Pentium processor, an AMD Opteron processor, an Apple A4 or A5 processor, a Sun UltraSPARC or IBM Power5+ processor and an IBM mainframe chip. The processor 510 is connected to other system components, including one or more memory devices 512, by the interconnection element 514.

The memory 512 stores programs and data during operation of the computer system 502. Thus, the memory 512 may be a relatively high performance, volatile, random access memory such as a dynamic random access memory (“DRAM”) or static memory (“SRAM”). However, the memory 512 may include any device for storing data, such as a disk drive or other nonvolatile storage device. Various examples may organize the memory 512 into particularized and, in some cases, unique structures to perform the functions disclosed herein. These data structures may be sized and organized to store values for particular data and types of data.

Components of the computer system 502 are coupled by an interconnection element such as the interconnection element 514. The interconnection element 514 may include one or more physical busses, for example, busses between components that are integrated within a same machine, but may include any communication coupling between system elements including specialized or standard computing bus technologies such as IDE, SCSI, PCI and InfiniBand. The interconnection element 514 enables communications, such as data and instructions, to be exchanged between system components of the computer system 502.

The computer system 502 also includes one or more interface devices 516 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 502 to exchange information and to communicate with external entities, such as users and other systems.

The data storage element 518 includes a computer readable and writeable nonvolatile, or non-transitory, data storage medium in which instructions are stored that define a program or other object that is executed by the processor 510. The data storage element 518 also may include information that is recorded, on or in, the medium, and that is processed by the processor 510 during execution of the program. More specifically, the information may be stored in one or more data structures specifically configured to conserve storage space or increase data exchange performance. The instructions may be persistently stored as encoded signals, and the instructions may cause the processor 510 to perform any of the functions described herein. The medium may, for example, be optical disk, magnetic disk or flash memory, among others. In operation, the processor 510 or some other controller causes data to be read from the nonvolatile recording medium into another memory, such as the memory 512, that allows for faster access to the information by the processor 510 than does the storage medium included in the data storage element 518. The memory may be located in the data storage element 518 or in the memory 512, however, the processor 510 manipulates the data within the memory, and then copies the data to the storage medium associated with the data storage element 518 after processing is completed. A variety of components may manage data movement between the storage medium and other memory elements and examples are not limited to particular data management components. Further, examples are not limited to a particular memory system or data storage system.

Although the computer system 502 is shown by way of example as one type of computer system upon which various aspects and functions may be practiced, aspects and functions are not limited to being implemented on the computer system 502. Various aspects and functions may be practiced on one or more computers having a different architectures or components than that shown in FIG. 5. For instance, the computer system 502 may include specially programmed, special-purpose hardware, such as an application-specific integrated circuit (“ASIC”) tailored to perform a particular operation disclosed herein. While another example may perform the same function using a grid of several computing devices running MAC OS X with IBM PowerPC processors and several specialized computing devices running proprietary hardware and operating systems.

The computer system 502 may be a computer system including an operating system that manages at least a portion of the hardware elements included in the computer system 502. In some examples, a processor or controller, such as the processor 510, executes an operating system. Examples of a particular operating system that may be executed include a Windows-based operating system, such as the Windows 8 operating system, available from the Microsoft Corporation, a MAC OS X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 510 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++ or Python. Thus, the examples are not limited to a specific programming language and any suitable programming language could be used. Accordingly, the functional components disclosed herein may include a wide variety of elements, e.g. specialized hardware, executable code, data structures or objects, which are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Embodiments are not limited in their application to the details of construction and the arrangement of components set forth in the following description or illustrated in the drawings. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the scope of the disclosure. Accordingly, the foregoing description and drawings are by way of example only.

What is claimed is:

1. A lodging reservation system for artists comprising:
a user interface;
a memory; and
a controller coupled to the memory, the controller being configured to:
receive at least one date and at least one associated location from an artist;
display the at least one date and the at least one associated location via the user interface;
receive at least one lodging offer from a host;
transmit the at least one lodging offer to the artist; and
receive at least one lodging selection from the artist.

2. The system of claim 1, wherein the controller further is configure to:
transmit a list of one or more artist packages to the host; and
receive a selection of an artist package from the list of one or more artist packages from the host.

3. The system of claim 2, wherein the artist package includes at least one of CDs, posters, show tickets, and apparel.

4. The system of claim 1, wherein the controller further is configured to receive at least one of a review of the artist from the host and a review of the host from the artist.

5. The system of claim 1, wherein the controller further is configured to prioritize displaying date and location information for the artist responsive to the artist meeting a first criterion.

6. The system of claim 5, wherein the first criterion one or more of a high popularity rating of the artist, a fee being paid by the artist, and a system membership account being held by the artist.

7. The system of claim 1, wherein the controller further is configured to receive a search request including a location.

8. The system of claim 7, wherein the user interface is configured to display one or more lodging requests near the location.

9. The system of claim 1, wherein the at least one lodging offer includes an aggregate rating and one or more reviews.

10. The system of claim 1, wherein the at least one lodging offer includes a description and images of the offered lodging.

11. A method of finding lodging for artists comprising:
receiving at least one date and at least one associated location from an artist;
displaying the at least one date and the at least one associated location via a user interface;
receiving at least one lodging offer from a host;
transmitting the at least one lodging offer to the artist; and
receiving at least one lodging selection from the artist.

12. The method of claim 11, wherein the method further comprises:
transmitting a list of one or more artist packages to the host; and
receiving a selection of an artist package from the list of one or more artist packages from the host.

13. The method of claim 12, wherein the artist package includes at least one of CDs, posters, show tickets, and apparel.

14. The method of claim 11, further comprising receiving at least one of a review of the artist from the host and a review of the host from the artist.

15. The method of claim 11, further comprising prioritizing displaying date and location information for the artist responsive to the artist meeting a first criterion.

16. The method of claim 15, wherein the first criterion includes at least one of a high popularity rating of the artist, a fee being paid by the artist, and a system membership account being held by the artist.

17. The method of claim 11, further comprising receiving a search request including a location.

18. The method of claim 17, further comprising displaying one or more lodging requests near the location by the user interface.

19. The method of claim 11, wherein the at least one lodging offer includes an aggregate rating and one or more reviews.

20. The method of claim 11, wherein the at least one lodging offer includes a description and images of the offered lodging.
